(19) United States
(12) Patent Application Publication
(10) Pub. No.: US 2018/0128028 A1
(43) Pub. Date: May 10, 2018

(54) LATCH SYSTEM WITH A HIGHLY VISIBLE HOOK LATCH AND METHOD FOR OPERATING SAID HOOK LATCH

(71) Applicant: Centrix Aero, LLC, Kent, WA (US)

(72) Inventor: Andres Hernandez, Kent, WA (US)

(21) Appl. No.: 15/806,116

(22) Filed: Nov. 7, 2017

Related U.S. Application Data
(60) Provisional application No. 62/419,279, filed on Nov. 8, 2016.

(51) Int. Cl. E05C 19/14; E05B 41/00; E05B 13/10; E05B 63/00; B64D 29/06

(52) U.S. Cl. CPC E05C 19/145; E05B 41/00; E05Y 2900/502; E05B 63/0056; B64D 29/06; E05B 13/10

(57) ABSTRACT

A hook latch is provided that includes a first attachment apparatus configured to pivotally attach to a first object and a second attachment apparatus configured to engage with a second object when the hook latch is in a closed configuration, where the second object is spaced away from the first object. The hook latch also includes a handle including a first end pivotally coupled to the second attachment apparatus and a second end adjacent to the first object when the hook latch is in the closed configuration and a linkage assembly configured to vary a position of the second attachment apparatus to allow the second attachment apparatus to engage with and disengage from the second object in response to actuation of the handle.

### CROSS REFERENCE TO RELATED APPLICATIONS

This application claims priority to U.S. Provisional Application No. 62/419,279, entitled “HIGH VISIBILITY HOOK LATCH,” filed Nov. 8, 2016, the entire contents of which is hereby incorporated by reference in its entirety for all purposes.

### TECHNICAL FIELD

This description relates generally to a latch system including a hook latch.

### BACKGROUND

Hook latches have been used to secure the two halves of an airplane engine cowling together. Typically the hook latch is located on the bottom of the engine, which can be difficult for ground personnel (e.g., mechanics, safety inspectors, flaggers, etc.,) to view and verify latch closure prior to takeoff. An unsecured hook latch can have catastrophic consequences for the airplane and its passengers. For instance, unsecured cowls have been the cause wing components damage, engine fires, etc., in the commercial airline industry. Furthermore, market demands to increase aircraft size and payloads have correspondingly led to increases in engine size. Hook latches on larger engine cowls are closer to the ground, exacerbating the visual inspection problems.

Attempts have been made to enhance the visibility of hook latches. For instance, streamers have been added to hook latches which are attached to a key that can only be removed when the latch is fully closed, similar to tag out procedures used in manufacturing. Others latch designs intended to increase latch visibility have included an additional handle that folds on top of the primary handle. However, both approaches include either additional parts within the latch or parts that are kept in the aircraft or by ground personnel. Both of the approaches therefore add complexity and weight to the latch mechanism, thereby increasing the cost of the latch.

### SUMMARY

The inventor has recognized the aforementioned problems and have confronted the problems by developing a hook latch that may resolve at least some of the shortcoming of prior hook latches. The hook latch includes a first attachment apparatus configured to pivotally attach to a first object and a second attachment apparatus configured to engage with a second object when the hook latch is in a closed configuration, where the second object is spaced away from the first object. The hook latch further includes a handle having a first end pivotally coupled to the second attachment apparatus and a second end adjacent to the first object when the hook latch is in the closed configuration. The hook latch also includes a linkage assembly configured to vary a position of the second attachment apparatus to allow the second attachment apparatus to engage with and disengage from the second object in response to actuation of the handle. Providing a latch with a handle that pivots in this manner enables the handle's visibility to be increased while the latch is opened, thereby decreasing the likelihood the latch being unintentionally left open subsequent to latch inspection. Specifically, when compared to previous latches, the handle extends further away from an engine cowling, or other attachable object, when the latch is open, increasing latch visibility. Accordingly, safety of vehicles (e.g., aircrafts), machines, devices, etc., using the hook latch is increased.

In one example, the handle pivots in an arc from a closed position to a fully open position, the arc having an angle greater than 90° and less than 180°. In this way, the visibility of the latch handle in an open position may be further increased, thereby improving latch safety.

In another example, the linkage assembly may include a load link pivotally coupled to the second attachment apparatus and a control link pivotally coupled to the load link and the handle. The control link is coupled to the handle at a location between a center of the handle and the first end of the handle. Designing the linkage assembly in this way enables the latch to be opened to an even greater extent, further increasing latch visibility. Designing the linkage assembly in this manner also enables the hook latch to efficiently and dependably open and close without an overly complex linkage assembly as is the case in some prior hook latches, such as hook latches with auxiliary handles. Accordingly, the latch mechanism can also achieve reductions in manufacturing costs and weight.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an engine cowl with a hook latch coupling sections of the engine cowl;

FIG. 2 shows an example of a hook latch in a closed configuration;

FIG. 3 shows a top view of the hook latch, shown in FIG. 2;

FIG. 4 shows a bottom view of the hook latch, shown in FIG. 2;

FIG. 5 shows an engine cowl with sections attached to one another via the hook latch, shown in FIG. 2, in a closed configuration;

FIG. 6 shows a cross-sectional view of the engine cowl and the hook latch in the closed configuration;

FIG. 7 shows a perspective view of the engine cowl and hook latch in the closed configuration;

FIG. 8 shows a sectional view of the engine cowl and hook latch, shown in FIG. 5, in a first partially open configuration;

FIG. 9 shows a perspective view of the hook latch in the first partially open configuration;

FIG. 10 shows a sectional view of the engine cowl and hook latch, shown in FIG. 5, in a second partially open configuration;

FIG. 11 shows a perspective view of the hook latch in the second partially open configuration;

FIG. 12 shows a sectional view of the engine cowl and hook latch, shown in FIG. 5, in a fully open configuration;

FIG. 13 shows a perspective view of the hook latch in the fully open configuration;

FIG. 14 shows a sectional view of the engine cowl and hook latch, shown in FIG. 5, in a fully open configuration where the hook latch hangs freely from the engine cowl;

FIG. 15 shows a perspective view of the hook latch in the fully open configuration where the hook latch freely hangs from the engine cowl; and

FIG. 16 shows a method for operating a hook latch.

FIGS. 2-15 are drawn to scale. However, other relative dimensions may be used in other embodiments.

### DETAILED DESCRIPTION

A high visibility hook latch is described herein that allows mechanics, safety inspectors, etc., to rapidly and reliably infer closure/non-closure of the hook latch. The hook latch may be used in commercial or military aircraft engine cowls. However, the applicability of the hook latch extends beyond the aerospace industry. For instance, the hook latch may be used in the automotive industry, manufacturing fields, the construction industry, etc. In one example, the hook latch includes a handle that pivots at one end adjacent to a hook. In this way, when the handle is actuated the handle pivots about the end such that a body of the handle extends away from the latch so that it can be quickly and easily viewed when in an open position. Specifically, the handle may pivot from a closed position to a fully open position in an arc having an angle between 90° and 180°. In this way, the position of the handle can be easily identified when the handle is fully opened. Consequently, the safety of aircrafts or other systems employing the latch may be increased.

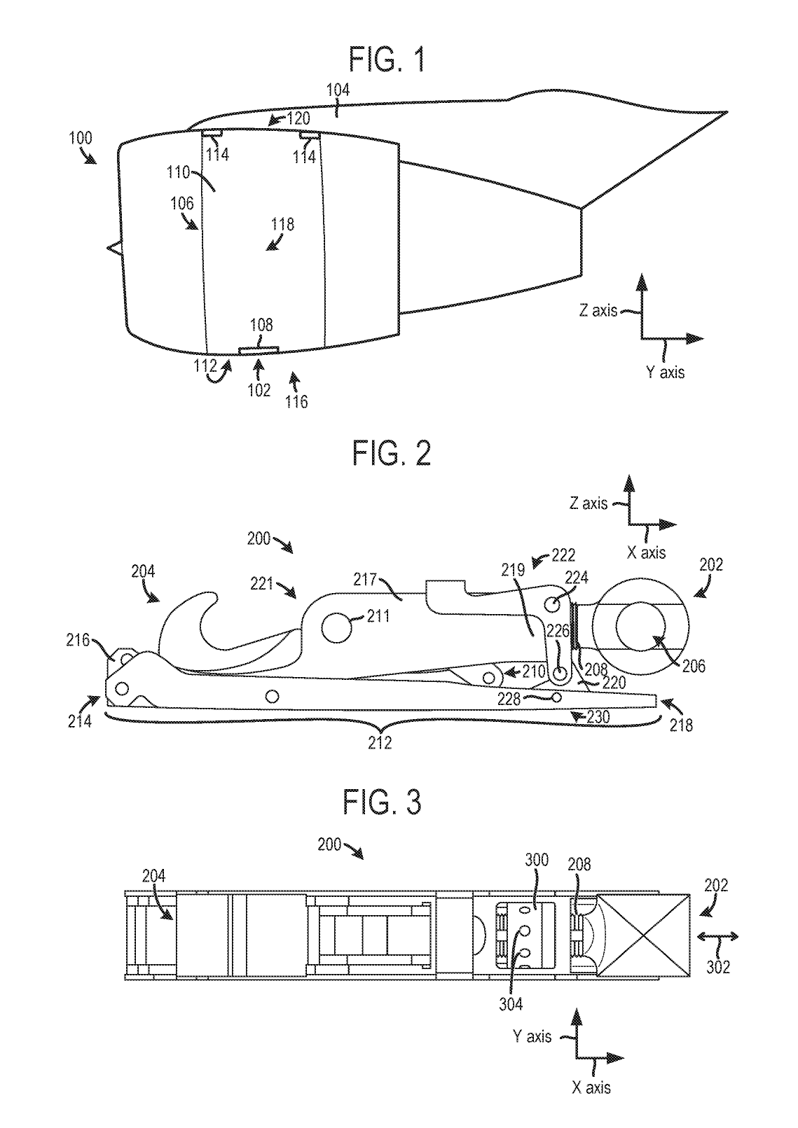

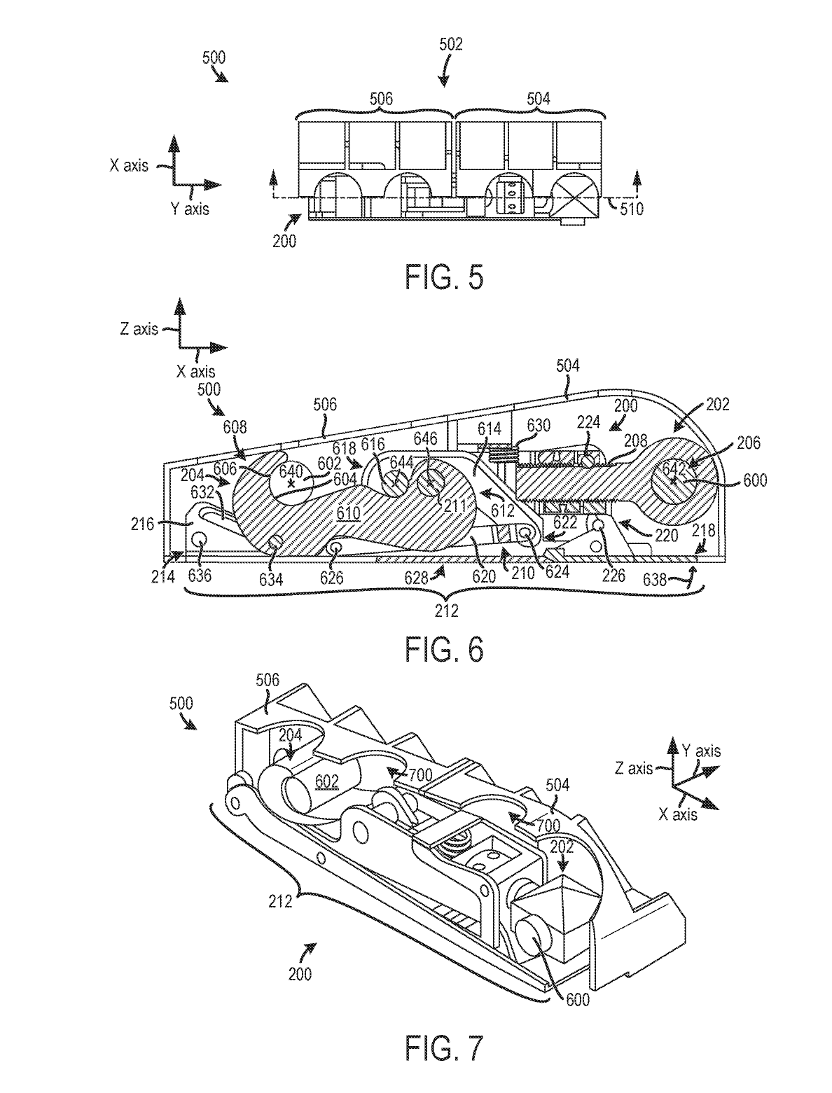

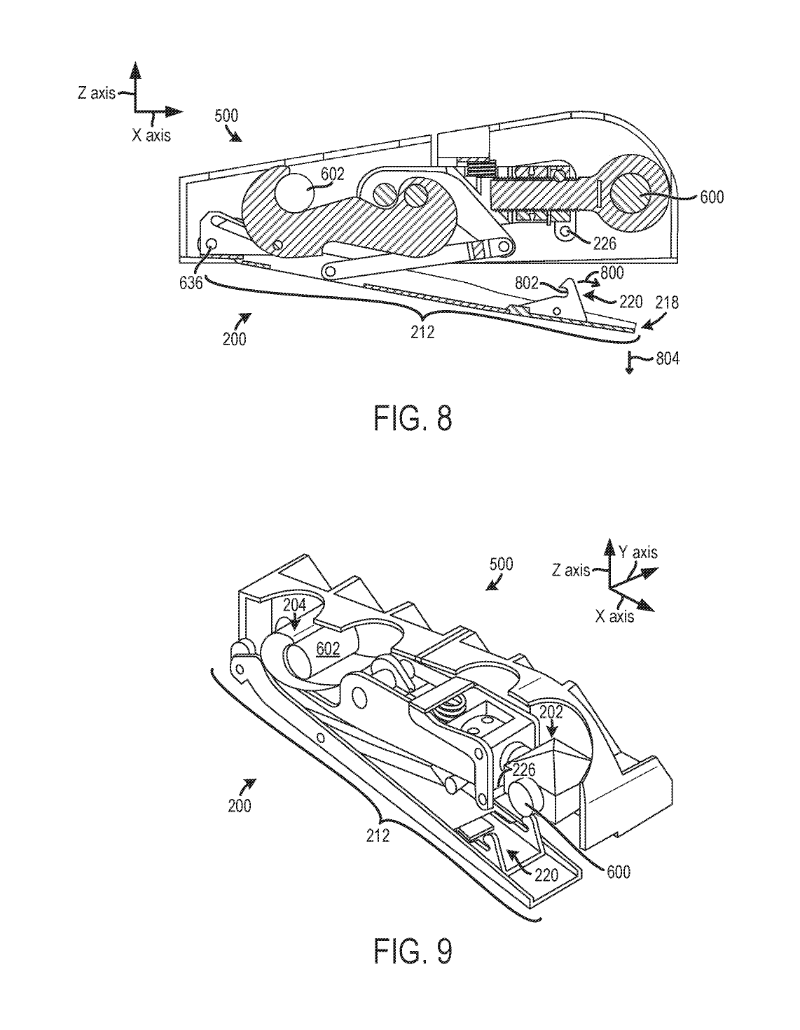

FIG. 1 shows an exemplary operating environment for a latch system including a hook latch. FIG. 2 shows a side view of an exemplary hook latch in a closed configuration. FIG. 3 shows a top view of the hook latch shown in FIG. 2. FIG. 4 shows a bottom view of the hook latch shown in FIG. 2. FIG. 5 shows the hook latch depicted in FIG. 2 attached to a cowl in a closed configuration. FIG. 6 shows a cross-section of the hook latch and cowl shown in FIG. 5. FIG. 7 shows a perspective view of the hook latch, depicted in FIG. 5. FIGS. 8-15 show different views of the hook latch, depicted in FIG. 5, in different stages of latch opening. FIG. 16 shows a method for operating a hook latch.

FIG. 1 illustrates a jet aircraft engine 100 with a latch system 102 (e.g., cowling system). The engine 100 is shown attached to a wing 104 of an aircraft. The latch system 102 includes a cowl 106 and a hook latch 108, in the illustrated example. Although the present examples are described and illustrated herein as being a latch system for use in a jet aircraft engine and specifically a jet engine cowl, the system described is provided as an example and not a limitation. Those skilled in the art will appreciate, the present example of the latch system is suitable for application in a variety of different settings, such as in prop driven aircrafts, or any setting where a highly visible hook latch is desirable such as in an automotive engines, in factory systems, in building systems, etc.

The cowl 106 has moveable cowl sections including a first cowl section 110 and a second cowl section 112 designed to pivot or otherwise move to reveal internal components in the engine 100. In this way, mechanics or other ground personnel can perform inspections, maintenance procedures, repair procedures, etc., as desired. The moveable cowl sections, 110 and 112, pivot about joints 114 positioned on a top side 120 of the engine 100, in the illustrated example. However, it will be appreciated that other locations of the cowl pivot joints have been contemplated.

The hook latch 108 is show positioned on an underside 116 of the cowl 106, in the example shown in FIG. 1. When the hook latch 108 is positioned under the cowl, mechanics may more easily access and open/close the cowl 106 during inspection, maintenance, and repair procedures. However, other hook latch positions have been contemplated such as locations on lateral sides 118 or the top side 120 of the cowl 106.

The hook latch 108 is schematically depicted in FIG. 1. However, it will be appreciated that the hook latch 108 has greater structural complexity. The structural features of the hook latch are described in more detail herein with regard to the exemplary hook latch shown in FIGS. 2-14. Furthermore, axes X, Y, and/or Z are provided in FIGS. 1-14 for reference. It will be appreciated that axes X, Y, and Z are perpendicular to one another. In one example, the Z axis may be parallel to a gravitational axis. In such an example, the X axis and the Y axis therefore have horizontal orientations. Specifically, in one example, the Y axis may be referred to as a longitudinal axis and the X axis may be referred to as a lateral axis. However, other orientations of the reference axes X, Y, and Z have been envisioned.

FIG. 2 shows a side view of an exemplary hook latch 200 in a closed configuration. It will be appreciated that the hook latch 200, shown in FIG. 2, is an example of the hook latch 200, shown in FIG. 1. The hook latch 200 includes a first attachment apparatus 202 and a second attachment apparatus 204. The attachment apparatuses are designed to attach to objects such as cowling sections. In the illustrated example, the first attachment apparatus is a bolt with an opening 206 at one end. The bolt also includes a threaded portion 208. However, other suitable types of attachment apparatuses that can pivotally attach to an object has been contemplated.

Furthermore, the second attachment apparatus 204 is a hook in the illustrated example. However, other types of attachment apparatuses may be used in other examples such as an eyelet bolt. The second attachment apparatus 204 is attached to a linkage assembly 210 via a pivot 211 (e.g., hook pivot). The linkage assembly 210 is designed to allow the second attachment apparatus 204 to engage with and disengage from an object (e.g., cowl pin) in response to actuation of a handle 212.

The handle 212 includes a first end 214 pivotally coupled to the second attachment apparatus 204 via a frame section 216 of a frame 221. The frame 221 also includes a central frame section 217. It will be appreciated that the frame 221 may be formed in a continuous shape. It will also be appreciated that the threaded portion 208 of the first attachment apparatus 202 may thread into a peripheral section 219 of the frame 221. Thus the frame 221 is attached to the first attachment apparatus 202. The handle also includes a second end 218 (e.g., a free end) adjacent to the first attachment apparatus 202 when the hook latch 200 is in the closed configuration. The second end 218 of the handle 212 may be manipulated by a mechanic or other ground personnel to open and close the latch.

The hook latch 200 further includes a trigger 220 and a trigger pin lever 222 pivoting about a lever pivot pin 224. The lever pivot pin 224 extends through an opening in the frame 221 in the example illustrated in FIG. 2. The trigger 220 is designed to engage with a trigger pin 226 in the trigger pin lever 222 when the hook latch 200 is in the closed configuration. In particular the trigger 220 is designed to pivot about a trigger pivot 228. The trigger pivot 228 may be spring loaded, in one example. In such an example, a trigger spring may exert a rotational force on the trigger when the trigger is rotated away from a neutral state. It will be appreciated that the neutral state of the trigger may correspond to the engaged position of the trigger, in one example. In this way, the trigger may secured in the engaged position, reducing the likelihood of unintended trigger disengagement. The engagement between the trigger pin 226 and the trigger 220 provides another degree of latch closure. Consequently, the likelihood of unintended latch disengagement is decreased, thereby increasing latch safety. Moreover, the engagement between the trigger pin 226 and the trigger 220 may provide haptic and/or audible feedback enabling ground personnel manipulating the latch to quickly and easily recognize latch closure. In the illustrated example, the trigger 220 and the trigger pin 226 may be engaged when they are aligned with the x-axis (e.g., horizontally aligned). Consequently, the likelihood of a person unintentionally leaving the latch open is reduced. However, in other examples, other engagement orientations between the trigger 220 and the trigger pin 226 have been contemplated. In one example, the handle 212 may be designed with an amount of free travel to enable a person to grasp the handle after the trigger 220 is unlocked from the trigger pin 226. For instance, the handle may swing down by a small amount (e.g., 5°, 2°, etc.,) after the trigger 220 is unlocked from the trigger pin 226.

FIG. 3 shows a top view of the hook latch 200 illustrated in FIG. 2. FIG. 3 depicts an adjustable nut 300 that threadingly engages with the threaded portion 208 of the first attachment apparatus 202. Rotational of the adjustable nut 300 causes axial translation of the first attachment apparatus 202 along an axis 302. In this way, the clamping load exerted by the first attachment apparatus 202 and the second attachment apparatus 204 on targeted objects when the latch is in the closed configuration may be adjusted. As a result, the adaptability of the hook latch is increased. The adjustable nut 300 includes detents 304 facilitating quick and easy hand adjustment of the nut. Thus, it will be appreciated that the adjustable nut 300 may be hand tightened via ground personnel. However in other examples, the adjustable nut may be rotated through the use of tools.

FIG. 4 shows a bottom view of the hook latch 200 illustrated in FIG. 2. A section 400 of the trigger 220 is shown extending through an opening 402 in the handle 212. The trigger section 400 (e.g., trigger release section) may act as a trigger release. Specifically, a person may depress a side 404 the trigger release section to move (e.g., rotate in a clockwise direction) the trigger 220 about the trigger pivot 228, shown in FIG. 3, to release the trigger 220 from the trigger pin 226. FIG. 4 also shows a section 406 of the frame 221 through which a handle pivot 636, shown in FIG. 6, extends.

FIG. 5 shows a latch system 500 including the hook latch 200, shown in FIG. 2, attaching sections of an engine cowl 502 together. It will be appreciated that the engine cowl 502 may be an example of the cowl 106, shown in FIG. 1. Additionally, the cowl sections may also be included in the latch system 500. Thus, the latch system is a cowling system, in the illustrated example. However, the latch system may be used to attach other suitable objects, as previously discussed. The engine cowl 502 specifically includes a first cowl section 504 and a second cowl section 506. The first cowl section 504 and the second cowl section 506 may pivot about joints in the manner described above with regard to FIG. 1. Therefore, the first and second cowl sections are two distinct portions of the cowl that may be moved apart from one another during engine inspection, for instance.

Viewing plane 510 shown in FIG. 5 indicates the cross-sectional view of the latch illustrated in FIG. 6. Moreover, the viewing plane 510 also indicates the cross-sectional views depicted in FIGS. 8, 10, 12, and 14. However, it will be appreciated that the hook latches shown in FIGS. 8, 10, 12, and 14 are in different opening configurations.

FIG. 6 shows a cross-sectional view of the latch system 500, shown in FIG. 5, in a closed configuration. The first and second attachment apparatuses, 202 and 204, are designed to clamp a first object 600 and a second object 602 together. In this way, the cowl sections may be securely closed. The first object 600 is included in the first cowl section 504 and the second object 602 is included in the second cowl section 506.

The first attachment apparatus 202 is shown pivotally attached to the first object 600, which is a first cowl pin, in the illustrated example. Specifically, the opening 206 in the first attachment apparatus 202 mates with (e.g., circumferentially surrounds) the first object 600. The second attachment apparatus 204 (e.g., a hook) is shown attached to the second object 602, which is a second cowl pin, in the illustrated example, while the hook latch is in the closed configuration. Specifically, the second attachment apparatus includes an interior surface 604 in face sharing contact or near face sharing contact with an outer surface 606 the second object 602. The second attachment apparatus 204 also include a first end 608, a body section 610, and a second end 612. The second end 612 is attached to the linkage assembly 210.

The linkage assembly 210 includes a load link 614. The load link 614 pivots about a load link pivot 616 at a first end 618 of the load link. Furthermore, the load link 614 is coupled to a control link 620 at a second end 622 of the load link via a first control link pivot 624. The control link 620 is pivotally coupled to the handle 212 via a second control link pivot 626. Additionally, the second control link pivot 626 is positioned between the first end 214 of the handle 212 and a center 628 of the handle 212. When the control link is attached to the handle 212 between the center 628 of the handle and the first end 214 of the handle the travel of the handle during opening and closing operation is increased, thereby increasing latch handle visibility. However, the handle 212 is in a closed position in FIG. 6. Furthermore, the aforementioned pivots may include circular openings mated with pins, in one example. However, other pivot designs have been contemplated such as pivots with bearings, bushings, etc. The second end 218 of the handle 212 is also shown in FIG. 6. When the handle 212 is in the closed position the second end 218 of the handle 212 is positioned adjacent to the first object 600.

The hook latch also includes a trigger spring 630. The trigger spring 630 is designed to exert a return force on the trigger pin lever 222, shown in FIG. 2, when the lever is pivoted about the lever pivot pin 224 during trigger engagement/disengagement. Specifically, the trigger spring 630 allows the trigger pin 226 to be displaced during engagement/disengagement with the trigger and then return to a neutral position while the trigger pin 226 is in an engaged or disengaged state. It will be appreciated that FIG. 6 illustrates the trigger pin lever 222 in a neutral state. However, other neutral state orientations of the trigger pin lever have been contemplated. Additionally, the trigger spring 630 is shown vertically oriented, in FIG. 6. However, in other examples, the trigger spring 630 may have a horizontal orientation (e.g., a spring where the coils wind around a horizontal axis).

FIG. 6 also shows the frame section 216 with a slot 632. A pin 634 extending from the second attachment apparatus 204 is mated with the slot 632. The slot 632 guides the first attachment apparatus 202 during opening and closure of the hook latch. Specifically, the slot 632 guides the first attachment apparatus 202 in horizontal directions during opening and closure of the hook latch. In this way, the hook may be guided away and toward the second object 602 during opening/closure of the latch. Thus the frame section 216 shifts toward the first attachment apparatus 202 during opening the hook latch.

Furthermore, the hook latch 200 shown in FIG. 6 may be an over-center hook latch designed to generate a moment arm on the handle 212 about the second control link pivot 626, acting as a fulcrum axis, in a direction 638 (e.g., counterclockwise direction) urging the handle into the closed position. Specifically, in the closed configuration the hook latch 200 may be preloaded to exert a closing force on the first object 500 and the second object 502.

FIG. 6 also shows the first end 214 of the handle 212 in a position that is laterally offset from the second object 602. Specifically, the first end 214 is positioned laterally outward from the second object 602. Positioning the handle in this manner enables the handle to swing further open when in an open configuration (e.g., fully opened configuration). Consequently, the visibility of the latch in the open configuration is increased. FIG. 6 also shows the center 640 of the second object 602, the center 642 of the first object 600, the center 644 of the load link pivot 616, and the center 646 of the pivot 211 (e.g., hook pivot) in lateral alignment when the latch is in the closed configuration. Additionally, the pivot 211 and the load link pivot 616 are positioned laterally between the first object 600 and the second object 602 when the hook latch 200 is in the closed configuration. FIG. 6 also shows a handle pivot 636. It will be appreciated that the handle 212 rotates about the pivot 636 when opened. FIG. 6 also shows the threaded portion 208 of the first attachment apparatus 202.

FIG. 7 shows a perspective view of the latch system 500 shown in FIG. 5. The hook latch 200 is again shown with the first attachment apparatus 202, the second attachment apparatus 204, and the handle 212. The first object 600 and the second object 602 are also shown in FIG. 7. The first cowl section 504 and the second cowl section 506 also include recesses 700. The recesses 700 may interface with engine components, in one example. The hook latch 200 urges the cowl sections 504 and 506 together to provide secure closure of the cowl sections. In FIG. 7, the cowl sections 504 and 506 adjacent to one another in face sharing or near face sharing contact when the latch is in the closed configuration. However in other examples, the cowl section 504 and 506 may have a gap therebetween when the latch is in the closed configuration.

FIGS. 8-15 show sequential stages of hook latch openings in the latch system 500. The opening sequence of the hook latch may be performed during engine inspection or repair, for instance.

FIG. 8 shows a cross-sectional view of the latch system 500 with the hook latch 200 in a partially open configuration. A mechanic or other personnel may release the trigger 220 from the trigger pin 226 by actuating the trigger 220. Specifically, the trigger 220 may be moved in a direction 800 (e.g., clockwise direction) away from the trigger pin 226 such that the trigger is released from the trigger pin 226. Additionally, the trigger 220 shown in FIG. 8 includes a hooked recess 802 that mates with the trigger pin 226 when the handle 212 is placed in the closed position.

After the trigger 220 is disengaged from the trigger pin 226, the second end 218 of the handle 212 is moved downward in a direction 804 away from the first object 600 to open the hook latch 200. In particular the handle 212 pivots about the handle pivot 636 when opened. Thus, the handle 212 is shown in FIG. 8 in a partially open position. It will be appreciated that a mechanic or other ground personnel may initiate opening of the hook latch through manipulation of the handle 212. Movement of the handle 212 in this manner unhooks the second attachment apparatus 204 from the second object 602. As such, in the open configuration the hook latch 200 is unclamped from the first and second objects, 600 and 602.

FIG. 9 shows a perspective view of the hook latch 200 in the latch system 500 in the first partially open configuration. The hook latch 200 is again shown with the first attachment apparatus 202, the second attachment apparatus 204, and the handle 212. The trigger 220 is also shown spaced away from the trigger pin 226. The first object 600 and the second object 602 are also depicted in FIG. 9. It will be appreciated that as the handle 212 is opened the visibility of the handle is increased. Consequently, mechanics may more easily infer the configuration of the latch (e.g., opened or closed configuration).

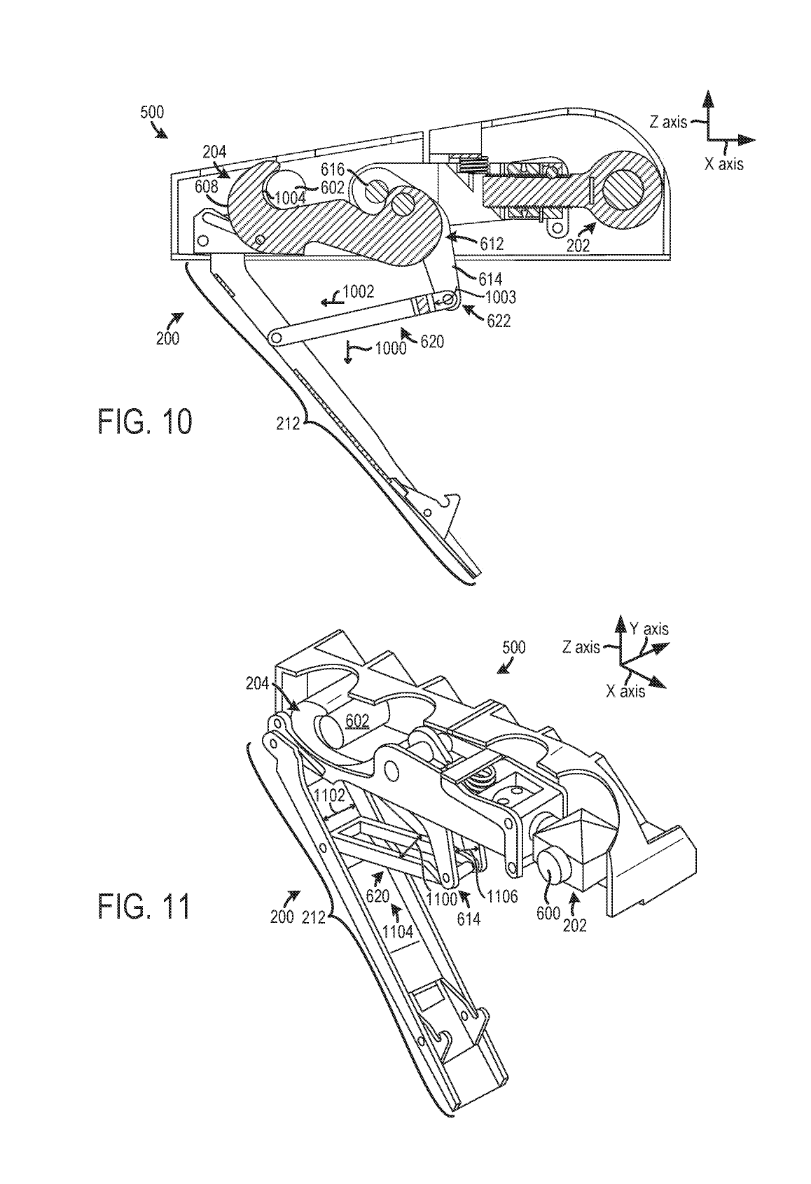

FIG. 10 shows a cross-sectional view of the latch system 500 with the hook latch 200 in a second partially open configuration. As illustrated, the handle 212 is moved further away from the first object 600 and the first attachment apparatus 202. Responsive to handle movement the control link 620 is moved downward, denoted via arrow 1000, and laterally outward, denoted via arrow 1002, which in turn causes the load link 614 to pivot about the load link pivot 616 such that the second end 622 of the load link moves in a clockwise direction 1003. Such movement of the load link 614 causes the second attachment apparatus 204 to move away and disengage from the second object 602. As such, a gap 1004 is formed between the second attachment apparatus 204 and the second object 602. Specifically, the second end 612 of the second attachment apparatus 204 moves downward and laterally outward toward the second object 602 to enable the first end 608 of the second attachment apparatus 204 to unhook from the second object.

FIG. 11 shows a perspective view of the hook latch 200 in the second partially open configuration. The hook latch 200 is again shown with the first attachment apparatus 202, the second attachment apparatus 204, and the handle 212. The first object 600 and the second object 602 are also illustrated in FIG. 11. A width 1100 of the control link 620 is less than an interior width 1102 of the handle 212. As a result, the control link 620 folds into an interior section 1104 of the handle during latch closure. In this way, the profile of the latch may be reduced. However, in other examples, the width of the control link may not be less than the width of the handle. Additionally, an internal width 1106 of the load link 614 is greater than the width 1100 of the control link 620, allowing the control link to pivot into the load link during latch closure. However, in other examples the internal width of the load link may be less than the width of the control link.

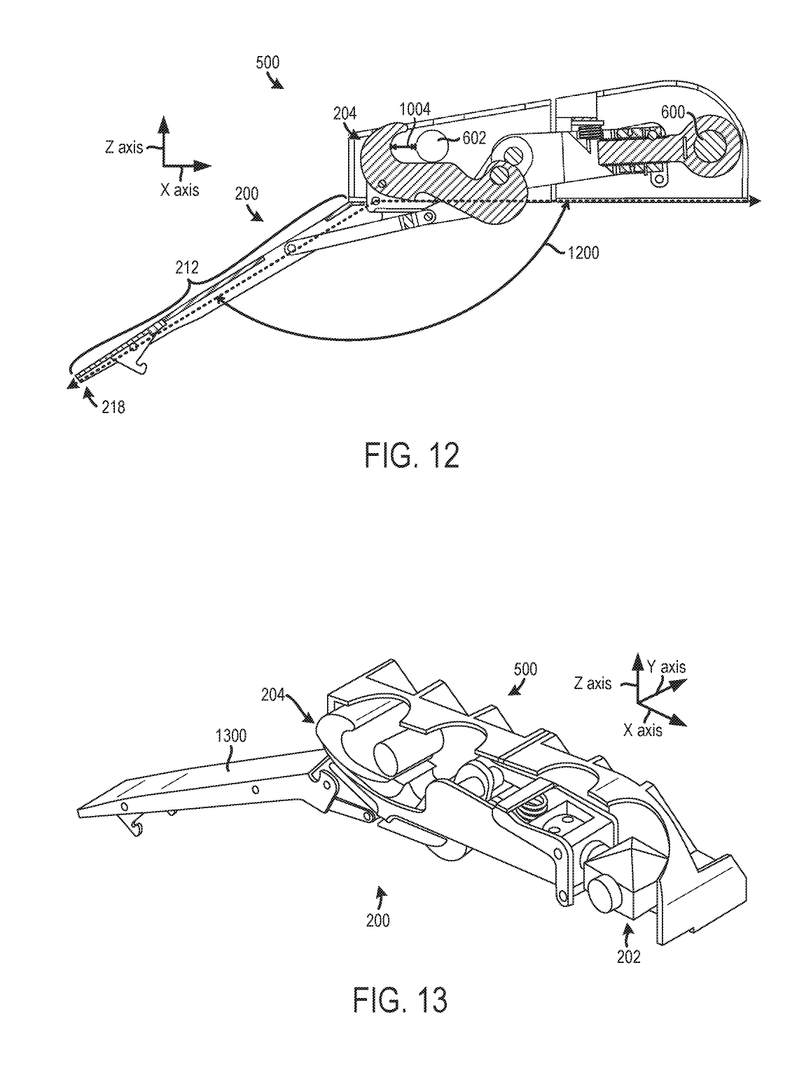

FIG. 12 shows a cross-sectional view of the latch system 500 with the hook latch 200 in a fully open configuration. As shown, the handle 212 is moved even further away from the first object 600. Responsive to handle movement the second attachment apparatus 204 is moved further away from the second object 602, thereby increasing the size of the gap 1004. Increasing the size of the gap in this manner enables the second attachment apparatus 204 (e.g., the hook) to be moved away from the second object 602 to enable a person to quickly and efficiently access an engine within the cowling.

Additionally, FIG. 12 depicts an arc 1200 through which the handle 212 travels from the closed position to the fully open position of FIG. 12. As previously discussed, the hook latch shown in FIG. 5 depicts the handle in a closed position. The path of the arc may be traced from a point on a plane extending through the handle 212 or specifically a point on a plane defined by an outer surface 1300 of the handle 212, shown in FIG. 13. In other examples, the arc 1200 may be traced from a point on the second end 218 of the handle 212.

Continuing with FIG. 12, the angle of the arc 1200 may be between 90° and 180°, in one example. In another example, the angle may be between 115° and 180°. Further in another example, the angle may between 150° and 180°. In yet another example, the angle of the arc 1200 may be between 165° and 180°.

It will be appreciated that the closer the arc angle is to 180° the more visible the latch may be when opened, thereby decreasing the likelihood of a mechanic unintentionally leaving the latch open, thereby increasing latch safety.

FIG. 13 shows a perspective view of the hook latch 200 in the latch system 500 in the fully open configuration. The hook latch 200 is again shown with the first attachment apparatus 202, the second attachment apparatus 204, and the handle 212. The first object 600 and the second object 602 are also illustrated in FIG. 13. The outer surface 1300 of the handle 212 is also depicted in FIG. 13. It will be appreciated that due to the position of the handle 212 the outer surface of the handle is highly visible to ground personnel.

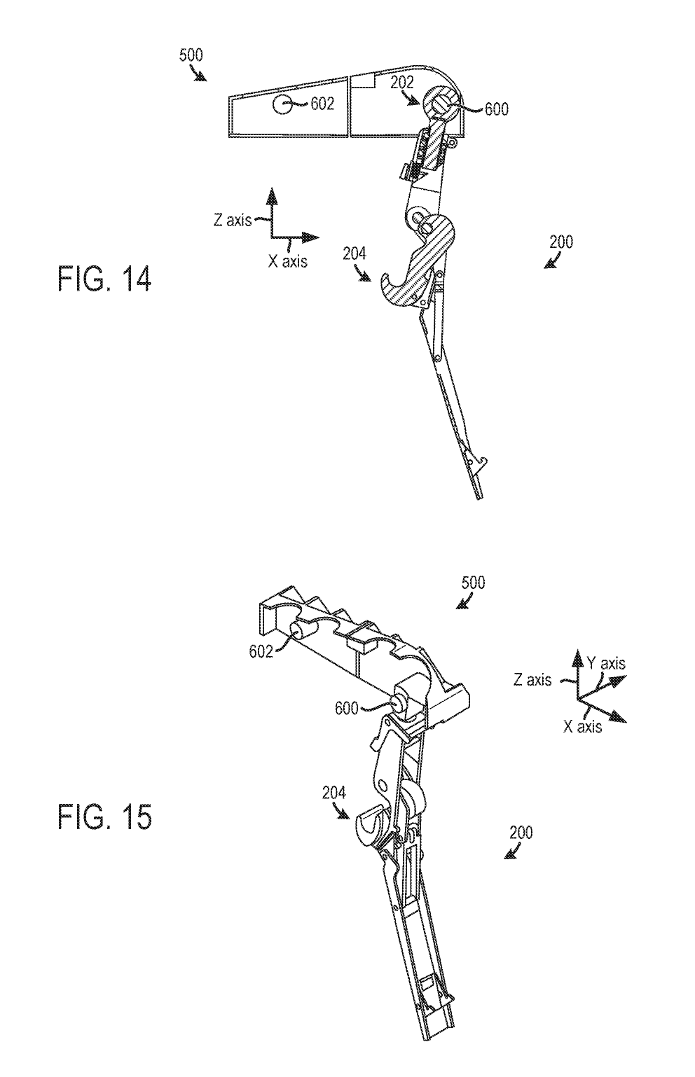

FIG. 14 shows a cross-sectional view of the latch system 500 with the hook latch 200 in the fully open configuration where the latch freely hangs from the first object 600. It will be appreciated that the pivotal attachment between the first attachment apparatus 202 and the first object 600 facilitates the free hanging of the hook latch 200. When the hook latch freely hangs from the first object 600 the second attachment apparatus 204 is moved downward and laterally toward the first object 600 and away from the second object 602. In this way, the latch visibility may be further improved. It will be appreciated that in the example shown in FIG. 14 the gravitational axis may be parallel to the Z axis.

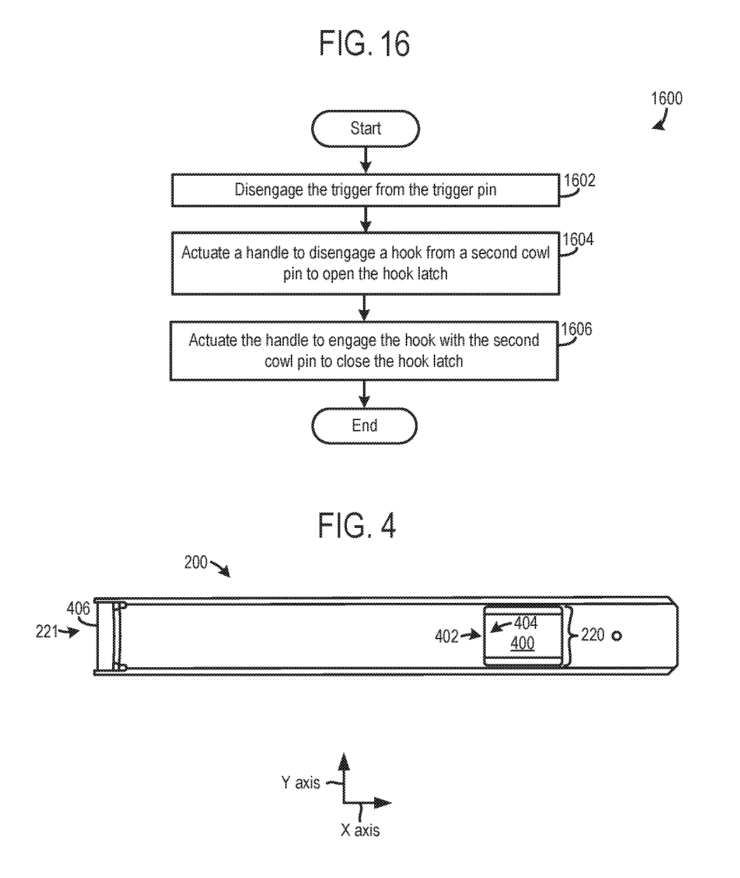

FIG. 15 shows a perspective view of the latch system 500 with the hook latch 200 in the fully open configuration where the latch freely hangs from the first object 600. FIG. 15 also shows the second attachment apparatus 204 spaced away from the second object 602.

The hook latch described herein has increased visibility which enables ground personnel to quickly identify latch closure. One feature of the latch that facilitates an increase in latch visibility includes positioning the handle pivot away from pivots in the linkage assembly. This features enables the handle to be spaced away from the objects to which the latch is attached to increase handle visibility without the need for additional components in the cowl, if desired, thereby reducing complexity, maintenance, and weight of the latch.

FIGS. 1-15 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

FIG. 16 shows a method 1600 for operation of a hook latch. The method may be implemented by the hook latch and latch system described above with regard to FIGS. 1-15 or may be implemented by other suitable hook latches and latch systems, in other examples.

At 1602 the method includes disengaging a trigger from a trigger pin in a hook latch. Disengaging the trigger from the trigger pin may include actuating a section of the trigger to rotate the trigger about a trigger pivot. In this way, the trigger may be rotated away from the trigger pin to facilitate disengagement. Next at 1604 the method includes actuating a handle to disengage a hook from a second cowl pin to open the hook latch. Actuating the handle to open the hook latch causes the linkage assembly to shift and move the hook away from the cowl pin. When the hook moves away from the second cowl pin the hook latch may swing down and freely hang from the first cowl pin attached to the first attachment apparatus.

Next at 1606 the method includes actuating the handle to engage the hook with the second cowl pin to close the hook latch. Actuating the handle to close the hook latch causes the linkage assembly to shift and urge the hook into a position where the cowl pin and the hook are engaged. It will be appreciated that the trigger and the trigger pin also engage with one another when the handle is moved into a fully closed position, thereby providing another degree of latch closure.

Those skilled in the art will realize that the process sequences described above may be equivalently performed in any order to achieve a desired result. Also, sub-processes may typically be omitted as desired without taking away from the overall functionality of the processes described above.

The invention will further be described in the following paragraphs. In one aspect, a hook latch is provided. The hook latch includes a first attachment apparatus configured to pivotally attach to a first object, a second attachment apparatus configured to engage with a second object when the hook latch is in a closed configuration, where the second object is spaced away from the first object, a handle including a first end pivotally coupled to the second attachment apparatus and a second end adjacent to the first object when the hook latch is in the closed configuration, and a linkage assembly configured to vary a position of the second attachment apparatus to allow the second attachment apparatus to engage with and disengage from the second object in response to actuation of the handle.

In another aspect, a cowling system is provided. The cowling system includes a cowl including a first cowl section and a second cowl section at least partially enclosing an engine, the first cowl section including a first cowl pin and the second cowl section including a second cowl pin, and a hook latch securing the first cowl section to the second cowl section in a closed configuration, the hook latch including, a first attachment apparatus pivotally attached to the first cowl pin, a second attachment apparatus engaging with the second cowl pin when the hook latch is in the closed configuration, a handle including a first end pivotally coupled to the second attachment apparatus and a second end adjacent to the first cowl pin when the hook latch is in the closed configuration, and a linkage assembly including a load link pivotally coupled to the second attachment apparatus, where movement of the load link about a load link pivot causes engagement or disengagement between the second cowl pin and the second attachment apparatus.

In another aspect, a hook latch is provided. The hook latch includes a bolt with an opening pivotally mating with a first cowl pin, a hook engaging with a second cowl pin when the hook latch is in a closed configuration, a handle including a first end pivotally coupled to the hook and a second end adjacent to the first cowl pin when the hook latch is in the closed configuration, where the handle pivots about the first end from a closed position to a fully opened position in an arc having an angle that is greater than 90° and less than 180°, and a linkage assembly including a load link pivotally coupled to the hook, where movement of the load link about a load link pivot causes engagement or disengagement between the hook and the second cowl pin.

In any of the aspects or combinations of the aspects, the handle may pivot about the first end in an arc from a closed positioned to a fully open position, the arc having an angle that is greater than 90° and less than 180°.

In any of the aspects or combinations of the aspects, the handle may include a trigger engaging with a trigger pin coupled to the first attachment apparatus when the hook latch is in the closed configuration.

In any of the aspects or combinations of the aspects, the linkage assembly, the handle, and the second attachment apparatus may pivot about and hang freely from the first object when the hook latch is in an open configuration.

In any of the aspects or combinations of the aspects, the linkage assembly may include a control link pivotally coupled to the handle at a location between a center of the handle and the first end of the handle.

In any of the aspects or combinations of the aspects, the first end of the handle may be positioned laterally offset from the second object when the hook latch is in the closed configuration.

In any of the aspects or combinations of the aspects, the first attachment apparatus may include a threaded portion engaging with an adjustable nut and where rotation of the adjustable nut varies an axial position of the first attachment apparatus.

In any of the aspects or combinations of the aspects, the first attachment apparatus may be a bolt with an opening and the first object is a first cowl pin and where the opening may mate with the first cowl pin.

In any of the aspects or combinations of the aspects, the second attachment apparatus may be a hook and the second object may be a second cowl pin and where the hook engages with the second cowl pin when the hook latch is in the closed configuration.

In any of the aspects or combinations of the aspects, the hook latch may be positioned on an underside of the cowl.

In any of the aspects or combinations of the aspects, the handle may pivot about the first end from a closed position to fully open position in an arc having an angle that is greater than 115° and less than 180°.

In any of the aspects or combinations of the aspects, the linkage assembly, the handle, and the second attachment apparatus may pivot about and hang freely from the first object when the hook latch is in an open configuration.

In any of the aspects or combinations of the aspects, the linkage assembly may include a control link pivotally coupled to the handle at a location between a center of the handle and the first end of the handle and a load link pivotally attached to the hook and the control link.

In any of the aspects or combinations of the aspects, the hook latch may be an over-center hook latch generating a moment arm on the handle about a fulcrum axis in a direction urging the handle into the closed position.

The detailed description provided above in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Note that the example control and estimation routines included herein can be used with various latch system configurations.

Various actions, operations, and/or functions illustrated and described herein may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used.

It will be appreciated that the configurations and routines disclosed herein are exemplary in nature, and that these specific embodiments are not to be considered in a limiting sense, because numerous variations are possible. For example, the above technology can be applied to a broad range of manufacturing fields such as the aerospace industry, the construction industry, the maritime industry, etc. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A hook latch comprising
a first attachment apparatus configured to pivotally attach to a first object;
a second attachment apparatus configured to engage with a second object when the hook latch is in a closed configuration, where the second object is spaced away from the first object;
a handle including a first end pivotally coupled to the second attachment apparatus and a second end adjacent to the first object when the hook latch is in the closed configuration; and
a linkage assembly configured to vary a position of the second attachment apparatus to allow the second attachment apparatus to engage with and disengage from the second object in response to actuation of the handle.

2. The hook latch of claim 1, where the handle pivots about the first end in an arc from a closed positioned to a fully open position, the arc having an angle that is greater than 90° and less than 180°.

3. The hook latch of claim 1, where the handle includes a trigger engaging with a trigger pin coupled to the first attachment apparatus when the hook latch is in the closed configuration.

4. The hook latch of claim 1, where the linkage assembly, the handle, and the second attachment apparatus pivot about and hang freely from the first object when the hook latch is in an open configuration.

5. The hook latch of claim 1, where the linkage assembly includes a control link pivotally coupled to the handle at a location between a center of the handle and the first end of the handle.

6. The hook latch of claim 1, where the first end of the handle is positioned laterally offset from the second object when the hook latch is in the closed configuration.

7. The hook latch of claim 1, where the first attachment apparatus includes a threaded portion engaging with an adjustable nut and where rotation of the adjustable nut varies an axial position of the first attachment apparatus.

8. The hook latch of claim 1, where the first attachment apparatus is a bolt with an opening and the first object is a first cowl pin and where the opening mates with the first cowl pin.

9. The hook latch of claim 8, where the second attachment apparatus is a hook and the second object is a second cowl pin and where the hook engages with the second cowl pin when the hook latch is in the closed configuration.

10. The hook latch of claim 1, where the first end of the handle is adjacent to the first object when the hook latch is in the closed configuration.

11. A cowling system comprising:
a cowl including a first cowl section and a second cowl section at least partially enclosing an engine, the first cowl section including a first cowl pin and the second cowl section including a second cowl pin; and
a hook latch securing the first cowl section to the second cowl section in a closed configuration, the hook latch including;
a first attachment apparatus pivotally attached to the first cowl pin;
a second attachment apparatus engaging with the second cowl pin when the hook latch is in the closed configuration;
a handle including a first end pivotally coupled to the second attachment apparatus and a second end adjacent to the first cowl pin when the hook latch is in the closed configuration; and
a linkage assembly including a load link pivotally coupled to the second attachment apparatus, where movement of the load link about a load link pivot causes engagement or disengagement between the second cowl pin and the second attachment apparatus.

12. The cowling system of claim 11, where the hook latch is positioned on an underside of the cowl.

13. The cowling system of claim 11, where the handle pivots about the first end from a closed position to fully open position in an arc having an angle that is greater than 115° and less than 180°.

14. The cowling system of claim 11, where the handle includes a trigger engaging with a trigger pin coupled to the first attachment apparatus when the hook latch is in the closed configuration.

15. The cowling system of claim 11, where the linkage assembly, the handle, and the second attachment apparatus pivot about and hang freely from the first object when the hook latch is in an open configuration.

16. A hook latch comprising:
a bolt with an opening pivotally mating with a first cowl pin;
a hook engaging with a second cowl pin when the hook latch is in a closed configuration;
a handle including a first end pivotally coupled to the hook and a second end adjacent to the first cowl pin when the hook latch is in the closed configuration, where the handle pivots about the first end from a closed position to a fully opened position in an arc having an angle that is greater than 90° and less than 180°; and
a linkage assembly including a load link pivotally coupled to the hook, where movement of the load link about a load link pivot causes engagement or disengagement between the hook and the second cowl pin.

17. The hook latch of claim 16, where the linkage assembly, the handle, and the second attachment apparatus pivot about and hang freely from the first object when the hook latch is in an open configuration.

18. The hook latch of claim 16, where the handle includes a trigger engaging with a trigger pin coupled to the first attachment apparatus when the hook latch is in the closed configuration.

19. The hook latch of claim 16, where the linkage assembly includes a control link pivotally coupled to the handle at a location between a center of the handle and the first end of the handle and a load link pivotally attached to the hook and the control link.

20. The hook latch of claim 16, where the hook latch is an over-center hook latch generating a moment arm on the handle about a fulcrum axis in a direction urging the handle into the closed position.
